(19) United States
(12) Patent Application Publication
(10) Pub. No.: US 2008/0214396 A1
(43) Pub. Date: Sep. 4, 2008

(54) Plant Treatment Agents

(76) Inventor: Douglas John Best, Launceston (AU)

Correspondence Address: JACOBSON HOLMAN PLLC, 400 SEVENTH STREET N.W., SUITE 600, WASHINGTON, DC, 20004, US

(21) Appl. No.: 11/628,267

(22) PCT Filed: Jun. 3, 2005
(86) PCT No.: PCT/NZ05/00113

§ 371 Date: Jan. 10, 2008

(30) Foreign Application Priority Data
Jun. 4, 2004 (NZ) 533350
Jul. 15, 2004 (NZ) 534117
Jul. 21, 2004 (NZ) 534218

(51) Int. Cl. A01N 59/00

(52) U.S. Cl. 504/101

(57) ABSTRACT

A slow release granule composition for the delivery of one or more plant treatment agents is described. The granule composition comprises a zeolite core with a surrounding layer of diatomite and an outer coating. Optionally, the granule composition further comprises dolomite. The granule composition is particularly useful for the controlled delivery of fertilisers and nutrients to plants and as a soil amendment.

### TECHNICAL FIELD

This invention relates to the controlled delivery of plant treatment agents. More particularly, a slow release granule composition suitable for application as a fertiliser and/or soil amendment is provided. A process for preparing such granules is also provided.

### BACKGROUND

Although fertilisers in liquid form are convenient to apply, they are generally viewed as being environmentally disadvantageous due to product run-off into streams, rivers, aquifers and underground water catchments. Other forms of fertiliser may also lead to pollution problems such as eutrophication in bodies of water which are exposed to run-off from land that has been treated with the fertiliser, for example from land which has been aerially top dressed with superphosphate. This has created a demand for fertilisers which slowly release their nutrients to the target plants and which significantly reduce pollution run-off.

It is an object of the present invention to provide an improved slow release granule composition; and/or to provide an improved slow release fertiliser formulation; and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In a first aspect, the present invention provides a slow release granule composition comprising a plant treatment agent, wherein the granule composition further comprises:
(a) a zeolite core;
(b) a layer of diatomite surrounding said zeolite core; and
(c) an outer coating.

In a further aspect, the present invention provides a slow release granule composition comprising an aqueous mixture of fish emulsion absorbed in a granule comprising a zeolite core coated with a mixture of diatomite and dolomite, and having an outer coating comprising gelatine.

In a yet further aspect, the present invention provides a slow release granule composition i comprising an aqueous mixture of fish emulsion absorbed in a granule comprising a zeolite core coated with a layer of diatomite, a layer of dolomite, a further layer of diatomite and having an outer coating comprising shellac.

In a still further aspect, the present invention provides a slow release granule composition comprising an aqueous mixture of fish emulsion absorbed in a granule comprising a zeolite core coated with a layer of diatomite, a layer of dolomite, a further layer of diatomite, a layer of potassium silicate primer and having an outer coating comprising a water-based resin comprising tree and plant exudates.

In another aspect, the present invention provides a slow release granule composition comprising an aqueous mixture of fish emulsion absorbed in a granule comprising a zeolite core coated with a layer of diatomite, a layer of dolomite, a further layer of diatomite, a layer of hydrated lime and having an outer coating comprising shellac.

In another aspect, the present invention provides a method of treating a plant with a plant treatment agent, comprising applying a slow release granule composition of the invention.

In another aspect, the present invention provides a process for preparing a slow release granule composition comprising a plant treatment agent, wherein the process comprises the steps of:
(a) dampening zeolite cores with a liquid;
(b) coating said dampened zeolite cores with diatomite; and
(c) applying a suitable outer coating material.

In another aspect, the present invention provides a slow release granule composition when prepared by a process of the invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The term “comprising”, or variations such as “comprises”, as used in this specification and claims means “consisting at least in part of”. That is to say when interpreting statements in this specification and claims which include that term, the features prefaced by that term in each statement all need to be present but other features can also be present.

Although the present invention is broadly as defined above, those persons skilled in the art will appreciate that the invention is not limited thereto and that the invention also includes embodiments of which the following description gives examples.

### DETAILED DESCRIPTION OF THE INVENTION

It will be appreciated by those skilled in the art that the present invention provides a slow release granule composition which permits the encapsulation of a large variety of natural and synthetic plant treatment agents to produce a number of useful formulations. Advantageously, the slow release granule composition also acts as a soil amendment.

In a first aspect, the present invention provides a slow release granule composition comprising a plant treatment agent, wherein the granule composition further comprises:
(a) a zeolite core;
(b) a layer of diatomite surrounding said zeolite core; and
(c) an outer coating.

The term “plant treatment agent” as used herein means any agrochemically active substance or mixture thereof, whether naturally or synthetically derived, which is customary for the treatment of plants to modulate the growth, health and/or fertility thereof. Preferred plant treatment agents include, but are not limited to: pesticides (for example, acaricides, algicides, fungicides, bactericides, viricides, insecticides, aphicides, miticides, nematicides, molluscicides, and the like); gametocides; herbicides; defoliants; desiccants; plant-growth regulators (including growth hormones); fertilisers; plant nutrients; and mixtures thereof.

Preferably, the plant treatment agent maintains or enhances plant growth, health and/or fertility. More preferably, the plant treatment agent comprises a pesticide, plant-growth regulator, fertiliser, plant nutrient or a mixture thereof.

Still more preferably, the plant treatment agent comprises a fertiliser, plant nutrient or mixture thereof.

As discussed above, fertilisers are generally formulated as liquids prior to application or are applied as water soluble solids which immediately release their nutrients to the environment upon dissolution.

In the present invention, the plant treatment agent is preferably absorbed in or adsorbed by the zeolite and/or the diatomite. The plant treatment agent is then released over time, as the zeolite and/or diatomite is hydrated and broken down in the soil environment.

In one embodiment, the plant treatment agent comprises a fertiliser derived from plant and/or animal sources. Examples of suitable sources include, but are not limited to: animal manure; compost and other decomposed animal and plant material; abattoir waste such as feather meal, blood meal and bone meal; dairy waste such as whey; plant material such as soybean meal, soy protein and alfalfa meal; seaweed; fish; and mixtures thereof.

Preferably, the fertiliser is an organically-certifiable fertiliser. A preferred organically-certifiable fertiliser is fish emulsion, for example European Carp emulsion. As well as providing nitrogen, phosphorous and potassium in an N:P:K ratio of approximately 9:2:6, European Carp emulsion also provides useful levels of a number of trace elements, for example boron, iron, manganese, zinc, molybdenum, cobalt, selenium and zinc.

Mixtures of fertilisers are also contemplated. In this way the N:P:K ratio and trace element content may be optimised for specific applications.

Preferably, the plant treatment agent is incorporated into the slow release granule composition as an aqueous solution, emulsion or suspension which is absorbed in or adsorbed by the zeolite and/or the diatomite. However, other embodiments are contemplated in which the plant treatment agent is incorporated as a solution or suspension in other solvents or mixtures of solvents.

In those embodiments wherein the plant treatment agent comprises fish emulsion, the emulsion may be diluted with water to form an aqueous mixture which is incorporated in the slow release granule composition. In this embodiment, the fish emulsion generally forms between about 95% and about 40% of the aqueous mixture.

In an alternative embodiment, the plant treatment agent comprises a powdered fertiliser, preferably in a microfine state, providing NPK and/or trace elements. In this embodiment, the powdered fertiliser may be mixed with one or more of the zeolite, diatomite and outer coating material. In a further alternative embodiment, the powdered fertiliser may be combined with a suitable bonding or coating agent prior to, or while, mixing with one or more of the zeolite, diatomite and outer coating material.

Embodiments in which a first solution, emulsion or suspension of the plant treatment agent is absorbed in or adsorbed by the zeolite while a second solution, emulsion or suspension of a different plant treatment agent is absorbed in or adsorbed by the diatomite are contemplated. Other embodiments in which a solution, emulsion or suspension of the plant treatment agent is absorbed in or adsorbed by only the zeolite or only the diatomite are also contemplated.

In a particularly preferred embodiment, the plant treatment agent comprises fish emulsion which is diluted with water and absorbed in or adsorbed by both the zeolite and diatomite.

Those persons skilled in the art will appreciate that the amount of plant treatment agent used in the slow release granule composition will depend on a number of factors which may include: the preferred application rate for the plant treatment agent; the concentration of the plant treatment agent or the solution, emulsion or suspension thereof; and the absorptivity or adsorptivity of the zeolite and/or the diatomite for the plant treatment agent or the solution, emulsion or suspension thereof.

Preferably, the zeolite is clinoptilolite.

Clinoptilolite is the most abundant mineral in the zeolite group and it occurs in extensive deposits throughout the world. Clinoptilolite may be used in many applications, for example as: cat litter; an industrial oil absorbent; a feed additive; and a gas absorbent. Clinoptilolite has excellent cation exchange properties which are particularly advantageous in a fertiliser formulation. For example, the cation exchange properties of clinoptilolite are believed to assist in ameliorating the affects of adverse chemical conditions such as high salinity.

Clinoptilolite sourced from New Zealand has excellent soil amendment properties and breaks down in the soil over moderate time periods. The term “soil amendment” as used herein means a material added to a soil to improve its physical properties, such as water retention, permeability, water infiltration, drainage, aeration and structure.

Furthermore, clinoptilolite has an inherent trace mineral content which makes it particularly beneficial for use in those embodiments wherein the plant treatment agent comprises a fertiliser.

Generally, zeolite comprises between about 40% and about 90% by weight of the solids in the slow release granule composition of the invention, wherein the term “solids” is taken to exclude the plant treatment agent. Preferably, zeolite comprises between about 60% and about 80% by weight of the solids in the slow release granule composition.

Diatomite is an amorphous siliceous sedimentary rock which is very finely porous and has a low density. Diatomite is essentially chemically inert in most liquids and gases and is used principally as a filter aid, but it has many other applications. For example, diatomite may be used as: an absorbent for industrial spills; pet litter; a filler in a variety of products from paints to dry chemicals; an insulation material; a mild abrasive in polishes; and a silica additive in cement and various other materials.

Preferably, the diatomite is freshwater diatomite. More preferably, the diatomite is freshwater diatomite obtained from Middlemarch, Otago, New Zealand. While marine diatomite is more common, freshwater diatomite sourced from this locality has favourable cation exchange properties as well as excellent water and oil absorption and adsorption properties. This diatomite also contains useful quantities of trace elements and organic carbon. In addition, this diatomite may provide advantageous release characteristics to the slow release granule composition.

The composition of the diatomite within any given deposit may vary. For example, the diatomite may occur as white, grey and/or black diatomite which, in addition to their colour, may be differentiated on the basis of their organic carbon content. Generally, white diatomite is oxidised and contains higher levels of mono- and ortho-silicic acid than black diatomite which contains higher levels of organic carbon. The deposit may also include transition zones of grey diatomite between strata of white and black diatomite. The organic carbon content may vary from less than about 1% for white diatomite up to and exceeding about 40% for black diatomite. Diatomite may be calcined or sintered to reduce the carbon content.

Middlemarch diatomite has advantageous heat and cold resistivity which may assist in protecting the slow release granule composition of the invention from the deleterious effects of climatic extremes, thereby enabling use of the composition in extremes of temperature. Black diatomite sourced from this locality also contains relatively high levels of humates and fulvates which render it particularly useful in those embodiments in which the plant treatment agent comprises a fertiliser.

Advantageously, upon breakdown in the soil, the organic carbon content of the diatomite in the slow release granule composition is released, for example as humates and fulvates that have a beneficial effect on the growth and development of plants. Accordingly, the present applicants have determined that appropriate selection of the carbon content of the diatomite used in the preparation of the slow release granule composition of the invention advantageously influences the properties of the composition, particularly in those embodiments wherein the plant treatment agent comprises a fertiliser. The carbon content of the diatomite is readily available as a nutrient and improves the soil structure and colour, particularly in sandy soils.

In a preferred embodiment, a combination of white and/or grey and/or black diatomite is used in the preparation of the slow release granule composition such that the average organic carbon content of the diatomite is between about 5% and about 25%.

In one embodiment, the slow release granule composition of the invention comprises additional humates and/or fulvates derived from extraneous sources. These may be obtained, for example, from the aqueous extracts of peat or from recycled putrescible material.

The diatomite may form one layer around the zeolite core. Alternatively, the diatomite forms multiple layers. The number and thickness of the diatomite layers will influence the rate of release of the plant treatment agent from the granule.

Generally, the diatomite comprises between about 10% and about 40% by weight of the solids in the slow release granule composition of the invention. Preferably, the diatomite comprises between about 15% and about 25% by weight of the solids in the slow release granule composition

Advantageously, upon breakdown in the soil, the slow release granule composition of the present invention releases mono-silicic acid and ortho-silicic acid which are readily absorbed by plants. In plants, silicon is believed to play a role in growth, mineral nutrition, mechanical strength and resistance to fungal diseases, and in modulating reaction to adverse chemical and physical conditions. Silicon affects the absorption and translocation of several macro- and micro-nutrients. In addition, silicon contributes to the strength and thickness of cell walls, thereby improving the mechanical strength of the plant and its resistance to attack by fungi and insects, as well as its ability to tolerate heat and frost.

In addition to influencing the release characteristics of the slow release granule composition, the outer coating provides abrasion resistance and improves the mechanical strength.

Materials suitable for use as the outer coating allow transfer of water and water vapour from the soil environment to the body of the slow release granule composition. Suitable outer coating materials include natural and synthetic materials known to those persons skilled in the art. It will be appreciated that the selection of final coating material is dependent upon such factors as dimensional strength, cost, colour, water vapour permeability and flexibility.

Suitable outer coating materials include, but are not limited to: proteins; resins; gums; waxes; and polysaccharides. Furthermore, synthetic materials such as methyl cellulose and acrylics may be used.

Preferred outer coating materials break down in the soil to leave minimal residue or footprint.

Preferred outer coating materials include: resins; starch; gluten; casein; whey protein isolate; soy protein isolate; zein; gelatine; and albumen. Mucilages (gelatinous substances obtained from various plants (such as legumes or seaweeds) that contain protein and polysaccharides and are similar to plant gums) may also be used. In addition, modified starches (for example, amylopectin) may be suitable.

More preferably, the outer coating material comprises shellac or gelatine.

The outer coating may be formed as one layer or as a number of layers. The thickness of the outer coating is determined by such factors as the selection and concentration of the coating material and the number of layers. Generally, the outer coating will have a thickness between about 1 μm and about 500 μm.

It will be appreciated that the thickness and composition of the outer coating will have a significant effect on the rate of release of the plant treatment agent from the granule. Furthermore, other factors such as temperature, pH, humidity and rainfall will also affect the rate of release of the plant treatment agent.

Upon breakdown in the soil, proteins release amino acids which provide macro- and micro-biota stimulation. Accordingly, selection of an outer coating material which comprises a protein component may advantageously influence the growth and/or health of the plant root structure in addition to above-ground plant growth, health and/or fertility.

Mixtures of materials may be used to form the outer coating, provided it is possible to prepare an homogenous mixture. Outer coatings having several layers, in which the composition of the individual layers may vary, are also contemplated. The outer coating may also include other ingredients such as plant treatment agents, colouring agents (for example, chlorophyll) and micro-organisms.

Generally, the outer coating layer comprises between about 0.5% and about 10% by weight of the solids in the slow release granule composition of the invention. Preferably, the outer coating layer comprises between about 0.5% and about 5% by weight of the solids in the slow release granule composition

In a preferred embodiment, all of the ingredients utilised in the preparation of the slow release granule composition of the invention are organically certifiable.

In a particularly preferred embodiment, the plant treatment agent is a fertiliser and the slow release granule composition is organically certifiable.

Previous attempts to prepare zeolite-based fertilisers have used non-organic ingredients. In addition, they have had poor slow release characteristics and an imbalance between macro- and micro-nutrients. Other slow release fertiliser formulations have been formulated using non-organic ingredients and synthetic coatings.

Advantageously, the slow release granule composition also contains entrained water derived from the materials used to prepare the granule.

Optionally, the slow release granule composition further comprises dolomite. The dolomite may provide additional nutrients.

The dolomite may be mixed with the diatomite. Alternatively, the dolomite may form one or more discrete layers within the granule, either adjacent to the zeolite core or to the outer coating, or separated from the zeolite core and/or the outer coating by one or more layers of diatomite.

When present, the dolomite comprises between about 3% and about 15% by weight of the solids in the slow release granule composition of the invention. Preferably, the dolomite comprises between about 5% and about 12% by weight of the solids in the slow release granule composition.

Optionally, the slow release granule composition further comprises hydrated lime. In one embodiment, the hydrated lime forms a discrete layer adjacent to the outer coating.

When present, the hydrated lime comprises between about 0.5% and about 2% by weight of the solids in the slow release granule composition of the invention. Preferably, the hydrated lime comprises between about 0.5% and about 1% by weight of the solids in the slow release granule composition.

The slow release granule composition of the invention may comprise a primer sealer which is applied to the granule surface to improve adhesion prior to the application of the outer coating. Suitable primer sealers include, but are not limited to, calcium bentonite and potassium silicate. When a primer sealer is used, the amount of the outer coating used to prepare the slow release granule composition is typically less than that used in the absence of the primer sealer. Upon breakdown of the slow release granule composition in the soil, the primer sealer may also have beneficial effects on the soil structure.

In those embodiments wherein calcium bentonite is used as the primer sealer, the calcium bentonite generally comprises between about 0.5% and about 6% by weight of the solids in the slow release granule composition.

In a particularly preferred embodiment, the present invention provides a slow release granule composition comprising an aqueous mixture of fish emulsion absorbed in a granule comprising a zeolite core coated with a mixture of diatomite and dolomite, and having an outer coating comprising gelatine.

In a particularly preferred embodiment, the present invention provides a slow release granule composition comprising an aqueous mixture of fish emulsion absorbed in a granule comprising a zeolite core coated with a layer of diatomite, a layer of dolomite, a further layer of diatomite and having an outer coating comprising shellac.

In a particularly preferred embodiment, the present invention provides a slow release granule composition comprising an aqueous mixture of fish emulsion absorbed in a granule comprising a zeolite core coated with a layer of diatomite, a layer of dolomite, a further layer of diatomite, a layer of potassium silicate primer and having an outer coating comprising a water-based resin comprising tree and plant exudates.

In a particularly preferred embodiment, the present invention provides a slow release granule composition comprising an aqueous mixture of fish emulsion absorbed in a granule comprising a zeolite core coated with a layer of diatomite, a layer of dolomite, a further layer of diatomite, a layer of hydrated lime and having an outer coating comprising shellac.

The present invention also provides a method of treating a plant with a plant treatment agent, comprising applying a slow release granule composition of the invention. Preferably, the slow release granule composition is applied under the soil surface in order to enhance micro-biota and root growth.

In another aspect, the present invention provides a process for preparing a slow release granule composition comprising a plant treatment agent, wherein the process comprises the steps of:
(a) dampening zeolite cores with a liquid;
(b) coating said dampened zeolite cores with diatomite; and
(c) applying a suitable outer coating material.

Preferably the liquid is a solution, emulsion or suspension of the plant treatment agent. More preferably, the liquid is an aqueous solution, emulsion or suspension of the plant treatment agent. However, other embodiments are contemplated in which the plant treatment agent is dissolved, emulsified or suspended in other solvents or mixtures of solvents.

Alternatively or additionally, the plant treatment agent may be a liquid or solid which is mixed with one or more of the zeolite cores, diatomite and outer coating material prior to use in a process of the invention.

Dampening the zeolite cores with a liquid enables adhesion of the diatomite to the surface of the zeolite cores. The quantity of liquid used will influence the amount of diatomite that will adhere to the cores. In one embodiment, the zeolite cores are dampened with sufficient liquid such that they are saturated, thereby enabling adhesion of multiple layers of diatomite. In this embodiment, step (b) is repeated to build up the desired number of concentric layers of diatomite around the zeolite cores.

In an alternative embodiment, each layer of diatomite is dampened with a further quantity of liquid to enable adhesion of further layers of diatomite or other material. This process is then repeated to give a granule with the required number of diatomite layers. In this embodiment, the liquid used to dampen the diatomite may be the same as or different from that used to dampen the zeolite cores.

In a particularly preferred embodiment, step (b) further comprises an additional step, subsequent to the building up of at least one layer of diatomite around the zeolite cores, wherein one or more layers of dolomite are built up around the diatomite-coated zeolite cores. Preferably, at least one further diatomite layer is built up around the one or more dolomite layers. In this embodiment, the zeolite cores may be saturated with the liquid to enable adhesion of the diatomite and dolomite layers without the addition of further quantities of liquid. Alternatively, further liquid may be used to dampen the diatomite and/or the dolomite to enable adhesion of the subsequent layer/s.

In an alternative embodiment, step (a) further comprises an additional step, wherein one or more layers of dolomite are built up around the dampened zeolite cores. At least one layer of diatomite is then built up around the dolomite-coated zeolite cores. In this embodiment, the zeolite cores may be saturated with the liquid to enable adhesion of the dolomite and diatomite layers without the addition of further quantities of liquid. Alternatively, further liquid may be used to dampen the dolomite and/or the diatomite to enable adhesion of the subsequent layer/s.

Accordingly, the process of the invention encompasses embodiments in which a first liquid is used to dampen the zeolite cores while a second and different liquid is used to dampen the diatomite. In this manner a granule may be prepared in which a first plant treatment agent is absorbed in or adsorbed by the zeolite cores while a second plant treatment agent is absorbed in or adsorbed by the diatomite. It will be further appreciated that, in those embodiments which include the formation of one or more dolomite layers, a third and different liquid may be used to dampen the dolomite thereby enabling a third plant treatment agent to be absorbed in or adsorbed by the dolomite.

Other embodiments in which a solution, emulsion or suspension of a plant treatment agent is absorbed in or adsorbed by only the zeolite cores, only the diatomite and/or only the dolomite are also contemplated. Further alternative embodiments in which a plurality of plant treatment agents are absorbed in or adsorbed by a plurality of discrete diatomite and/or dolomite layers are also contemplated.

In those embodiments wherein the plant treatment agent is a liquid or solid which is mixed with one or more of the zeolite cores, diatomite and outer coating material prior to use in the process, the liquid may be a solution, emulsion or suspension of the same or a different plant treatment agent, or the liquid may be water, or a solvent or mixture of solvents, and simply enable adhesion.

Preferably, the slow release granule composition has, in total, one to ten diatomite layers. In a particularly preferred embodiment, the composition has two to seven diatomite layers.

Preferably, the particle size of the diatomite is between about 30 μm and about 400 μm. More preferably, the particle size of the diatomite is between about 75 μm and about 200 μm. In a particularly preferred embodiment, the particle size of the diatomite is about 100 μm.

Preferably, the surface of the formed granule is at least partially dried before applying the outer coating. The granule surface may be dried by the application of heat. Alternatively or additionally, the granule surface may be dried by the addition of a water absorbent material.

In one embodiment, the water absorbent material is hydrated lime. In this embodiment, the hydrated lime generally comprises between about 0.5% and about 2% by weight of the solids in the slow release granule composition of the invention. Preferably, the hydrated lime comprises between about 0.5% and about 1% by weight of the solids in the slow release granule composition.

Generally, the outer coating is applied as a solution, emulsion or suspension which is sprayed onto the granules. The resulting coated granules are then dried, optionally by the application of heat. In those embodiments wherein the outer coating is applied in multiple layers, the coated granules are typically at least partially dried before the application of each additional layer.

The process of the invention may be applied using suitable equipment as is well known in the art. Such equipment includes orbital mixers and the like. The invention also provides a slow release granule composition when prepared by a method of the invention.

Typically, the slow release granule composition of the invention is a granule with a diameter of about 5 mm. Such granules may be prepared from zeolite that has been crushed to a particle size of between about 1 mm and about 4 mm. However, it will be appreciated that by selecting zeolite cores of an appropriate size and the number of diatomite and/or dolomite layers, granules of varying sizes may be prepared. Accordingly, granules of up to at least 10-12 mm may be prepared. Granule size may also influence the rate of release of the plant treatment agent from the granule. However, larger granules will be heavier and may not be suitable for application by aircraft or mechanical throwers.

The following non-limiting examples are provided to illustrate the present invention and in no way limit the scope thereof.

### EXAMPLES

Materials

(a) Source

Zeolite is obtained as clinoptilolite from a deposit at Matamata in the North Island of New Zealand and sourced through Resource Refineries Ltd, Waharoa, New Zealand. The zeolite is crushed to a particle size of −4 mm +1 mm.

White diatomite and black diatomite are obtained from Middlemarch, Central Otago, New Zealand and sourced through Featherston Resources Ltd, Wellington, New Zealand. The diatomite is wind rowed and subsequently dried to a moisture content of approximately 30% prior to use. The diatomite is crushed to a maximum particle size of approximately 15 mm, prior to milling to an average particle size of approximately 100 μm.

Dolomite is obtained from Omya New Zealand Ltd, Auckland, New Zealand. The dolomite has an average particle size of approximately 150 μm.

European Carp emulsion (Charlie Carp®) is obtained from Four Seas (NSW) Pty Ltd, Denaliquin, New South Wales, Australia.

Other materials are obtained from standard commercial sources.

(b) Analysis

Samples of white diatomite and of black diatomite were analysed for carbon and nitrogen content to give the following results:
Black diatomite, found: 12.2% carbon; 0.34% nitrogen. White diatomite, found: 0.8% carbon; 0.07% nitrogen.

The fulvic acid and humic acid content of duplicate samples of white diatomite and of black diatomite were determined. The method used is described by Anderson and Schoenau Soil-humus fractions in M. R. Carter (ed.) “Soil sampling and methods of analysis” (1993) Canadian Society of Soil Science, Lewis Publishers, Boca Raton, Fla. The samples were treated to obtain fulvic acid and humic acid extracts that were analysed for organic carbon—which makes up approximately 50% of fulvic and humic acid—to give the following results:
Black diatomite—sample 1, found: 3067.4 mg/kg fulvic acid; 5760.1 mg/kg humic acid; sample 2, found: 1853.9 mg/kg fulvic acid; 4068.5 mg/kg humic acid. White diatomite—sample 1, found: 1022.2 mg/kg fulvic acid; 227.4 mg/kg humic acid; sample 2, found: 1162.6 mg/kg fulvic acid; 122.5 mg/kg humic acid.

### Example 1

Zeolite (600 kg) is loaded into a variable speed tube-type orbital mixer, the rotational axis of which may be varied between about 15° and about 40° from horizontal, and the mixer started. An aqueous mixture of European Carp emulsion (300 kg, 50% by weight) is slowly added. A mixture of white diatomite (70 kg), black diatomite (70 kg) and dolomite (66 kg) is prepared. After approximately 10 minutes, the diatomite mixture is added to the dampened zeolite in three equal portions alternating with three equal amounts of an aqueous mixture of European Carp oil (total 290 kg, 50% by weight). The resulting granules are then flash heated to approximately 140° C. for approximately three minutes using a gas-fired forced air heater directed into the mouth of the mixer. A solution of gelatine (6 kg) dissolved in water (114 kg, 60° C.) is then sprayed onto the granules which are then dried to give a total product weight of approximately 1400 kg.

### Example 2

A nutrient mixture is prepared by mixing European Carp emulsion (186 litres) with water (20 litres). A mixture of white diatomite (22 kg) and black diatomite (22 kg) is prepared. Zeolite (200 kg) is loaded into the orbital mixer described in Example 1 and the mixer started. The zeolite is slowly dampened with about half of the total nutrient mixture. After approximately 10 minutes, the diatomite mixture is added to the dampened zeolite in several portions, alternating with sufficient nutrient mixture to dampen the surface of the resulting granules. The diatomite-coated granules are then dampened with further nutrient mixture and dolomite (30 kg) is added. Black diatomite (6 kg) is then added in several portions, alternating with the remaining nutrient mixture. The resulting uncoated granules are flash heated as in Example 1. A solution of shellac (5 kg) dissolved in ethanol (45 litres*) is then sprayed onto the granules in about five portions, and the granules are at least partially dried by flash heating between the addition of each portion. The resulting granules are then heated and dried to give a total product weight of approximately 500 kg.

* In summer the ethanol may be diluted with approximately 3 litres of water.

### Example 3

(a) Preparation

Two samples of uncoated granules were prepared according to the procedure described in Example 2. The first sample (Fertiliser #1 100%) was prepared using the same nutrient mixture prepared from European Carp emulsion and water as in Example 2, while the second sample (Fertiliser #2 50%) was prepared using the nutrient mixture diluted with water (1:1, v/v). Both samples were treated with a potassium silicate primer to improve adhesion, and coated with a natural water-based resin comprising tree and plant exudates. This coating system was selected in order to prevent bleeding from the granule composition—thereby maintaining its integrity between preparation and analysis—and because it was thought unlikely to significantly contribute to the analytical results.

(b) Analysis

The samples were then dried at 60° C. and analysed to give the following results:

| | Fertiliser # 1 100% | Fertiliser # 2 50% |
|---|---|---|
| Nitrogen % w/w | 3.1 | 1.5 |
| Carbon % w/w | 6.1 | 5.1 |
| Total Phosphorus % w/w | 0.64 | 0.3 |
| Potassium % w/w | 2.32 | 1.34 |
| Sulphate-Sulphur % w/w | 0.42 | 0.24 |
| Calcium % w/w | 1.25 | 1.19 |
| Magnesium % w/w | 0.36 | 0.38 |
| Iron mg/kg | 5304 | 6774 |
| Copper mg/kg | 40 | 21 |
| Zinc mg/kg | 120 | 82 |
| Boron mg/kg | 270 | 420 |
| Manganese mg/kg | 206 | 147 |
| Aluminium mg/kg | 12704 | 12138 |
| Chloride % w/w | 1.84 | 1.06 |
| SiO₂ % | 54.75 | 60.26 |

### Example 4

Zeolite (420 kg) is loaded into the orbital mixer described in Example 1, and the mixer started. A mixture of European Carp emulsion (336 litres) in water (63 litres) is prepared and slowly added. A mixture of white diatomite (39 kg) and black diatomite (78 kg) is prepared. After approximately 10 minutes, half of the diatomite mixture is added to the saturated zeolite. Dolomite (53 kg) is then added, followed by the remaining diatomite mixture. Hydrated lime (4.5 kg) is then added in order to absorb excess moisture from the surface of the resulting granules. The granules are flash heated as in Example 1. A solution of shellac (12.6 kg) dissolved in ethanol (60 litres*) is then sprayed onto the granules in about four or five portions, and the granules are at least partially dried by flash heating between the addition of each portion. The resulting granules are then heated and dried to give a total product weight of approximately 1000 kg.

* In summer the ethanol may be diluted with approximately 5 litres of water.

### INDUSTRIAL APPLICATION

It will be appreciated that, in use, the present invention provides a means by which a plant treatment agent may be delivered to a plant in a controlled manner. In particular, the present invention provides a slow release fertiliser formulation in granular form suitable for application by airborne delivery, spreader or hand. Such a fertiliser may be used where enhanced plant growth is desirable, for example in orchards, vineyards, nurseries, pasture, broadacre crops and domestic pot plants.

Advantageously, the present invention provides for the production of slow or calibrated release fertiliser pellets which are of a suitable weight for application by mechanical spreaders or for airborne application with minimal windrift.

The combination of macro- and micro-elements in suitable proportions together with the incorporation of carbon, and the ability to release mono- and ortho-silicic acid, mean that the present invention is particularly applicable to the preparation of a fertiliser formulation. The materials used to prepare the formulation of the present invention are such that the formulation also possesses advantageous soil amendment properties.

It will be appreciated by those skilled in the art that the release characteristics of a fertiliser formulation prepared according to the invention may be tuned by varying the granule size and the number of layers around the zeolite core and, furthermore, by altering the number and thickness of outer coating layers.

It is not the intention to limit the scope of the invention to the abovementioned examples only. As would be appreciated by a skilled person in the art, many variations are possible without departing from the scope of the invention (as set out in the accompanying claims).

1-66. (canceled)

67. A slow release granule composition comprising a plant treatment agent, wherein the granule composition further comprises:
(a) a zeolite core;
(b) a layer of diatomite surrounding said zeolite core; and
(c) an outer coating.

68. The slow release granule composition as claimed in claim 67 wherein the plant treatment agent is selected from the group consisting of: pesticides; gametocides; herbicides; defoliants; desiccants; plant-growth regulators; fertilisers; plant nutrients; and mixtures thereof.

69. The slow release granule composition as claimed in claim 67 wherein the plant treatment agent comprises a fertiliser, plant nutrient or mixture thereof.

70. The slow release granule composition as claimed in claim 67 wherein the zeolite is clinoptilolite.

71. The slow release granule composition as claimed in claim 67 wherein the zeolite comprises between about 40% and about 90% by weight of the solids in the composition.

72. The slow release granule composition as claimed in claim 67 wherein the diatomite is freshwater diatomite.

73. The slow release granule composition as claimed in claim 67 wherein the average organic carbon content of the diatomite is between about 5% and about 25%.

74. The slow release granule composition as claimed in claim 67 wherein the diatomite forms one layer around the zeolite core.

75. The slow release granule composition as claimed in claim 67 wherein the diatomite forms multiple layers around the zeolite core.

76. The slow release granule composition as claimed in claim 67 wherein the diatomite comprises between about 10% and about 40% by weight of the solids in the composition.

77. The slow release granule composition as claimed in claim 67 wherein the outer coating material is selected from the group consisting of: synthetic materials; proteins; resins; gums; waxes; polysaccharides; and mixtures thereof.

78. The slow release granule composition as claimed in claim 67 wherein the outer coating material comprises shellac or gelatine.

79. The slow release granule composition as claimed in claim 67 wherein the outer coating layer comprises between about 0.5% and about 10% by weight of the solids in the composition.

80. The slow release granule composition as claimed in claim 67 further comprising dolomite.

81. The slow release granule composition as claimed in claim 80 wherein the dolomite is mixed with the diatomite.

82. The slow release granule composition as claimed in claim 80 wherein the dolomite forms one or more discrete layers within the granule.

83. The slow release granule composition as claimed in claim 80 wherein the dolomite comprises between about 3% and about 15% by weight of the solids in the composition.

84. The slow release granule composition as claimed in claim 67 further comprising calcium bentonite or potassium silicate.

85. The slow release granule composition as claimed in claim 67 further comprising hydrated lime.

86. The method of treating a plant with a plant treatment agent, comprising applying a slow release granule composition as claimed in claim 67.

87. A process for preparing a slow release granule composition comprising a plant treatment agent, wherein the process comprises the steps of:
(a) dampening zeolite cores with a liquid;
(b) coating said dampened zeolite cores with diatomite; and
(c) applying a suitable outer coating material.

88. The process for preparing a slow release granule composition as claimed in claim 87 wherein step (b) is repeated to build up a number of concentric layers of diatomite around the zeolite cores.

89. The process for preparing a slow release granule composition as claimed in claim 87 wherein step (b) further comprises an additional step, subsequent to the building up of at least one layer of diatomite around the zeolite cores, wherein one or more layers of dolomite are built up around the diatomite-coated zeolite cores.

90. The process for preparing a slow release granule composition as claimed in claim 89 wherein at least one further diatomite layer is built up around the one or more dolomite layers.

91. The process for preparing a slow release granule composition as claimed claim 87 wherein step (a) further comprises an additional step, subsequent to the dampening of the zeolite cores, wherein one or more layers of dolomite are built up around the zeolite cores.

92. The process for preparing a slow release granule composition as claimed in claim 87 wherein the liquid is a solution, emulsion or suspension of a plant treatment agent.

93. The process for preparing a slow release granule composition as claimed in claim 87 wherein the surface of the formed granule is at least partially dried before applying the outer coating.

94. The process for preparing a slow release granule composition as claimed in claim 93 wherein the surface of the formed granule is at least partially dried by the addition of a water absorbent material.

95. The process for preparing a slow release granule composition as claimed in claim 94 wherein the water absorbent material is hydrated lime.

96. The process for preparing a slow release granule composition as claimed in claim 87 further comprising drying the coated granules.
